(19) United States
(12) Patent Application Publication
(10) Pub. No.: US 2007/0297081 A1
(43) Pub. Date: Dec. 27, 2007

(54) Magnetic device for current assisted magnetic recording

(75) Inventors: Alexey V. Nazarov, Edina, MN (US); Olle G. Heinonen, Eden Prairie, MN (US); Bharat B. Pant, Minneapolis, MN (US); Kaizhong Gao, Eden Prairie, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/475,685

(22) Filed: Jun. 27, 2006

(51) Int. Cl. G11B 5/02

(52) U.S. Cl. 360/59

(57) ABSTRACT

An apparatus includes a write element for writing to a medium. The apparatus is configured to effectuate an electrical potential difference between a portion of the apparatus and a portion of the medium such that a current flows between the apparatus and the medium to reduce a coercivity of the medium proximate to the write element.

### BACKGROUND OF THE INVENTION

The present invention relates to magnetic devices. More particularly, the present invention relates to a recording system including a device that employs a current to heat a portion of a magnetic medium.

As areal densities increase, smaller bit cells are required in the magnetic medium (track width and bit length). However, superparamagnetic instabilities become an issue as the grain volume (i.e., the number of grains in the media per bit cell) of the recording medium is reduced in order to control media noise for high areal density recording. One benchmark related to the superparamagnetic effect that may be used is that, for a grain volume V, the superparamagnetic effect becomes more evident when the inequality KᵤV/k_{B}T>70 can no longer be maintained. Kᵤ is the material's magnetic crystalline anisotropy energy density, k_{B} is Boltzmann's constant, and T is absolute temperature. When this inequality is not satisfied, thermal energy demagnetizes the stored bits. Therefore, as the grain size is decreased in order to increase the areal density, a threshold is reached for a given material Kᵤ and temperature T such that stable data storage is no longer feasible.

The thermal stability can be improved by employing a recording medium formed of a material with a very high Kᵤ. However, with available materials the recording heads are not able to provide a sufficient or high enough magnetic writing field to write on such a medium. Accordingly, it has been proposed to overcome the recording head field limitations by employing thermal energy to heat a local area on the recording medium before or at about the time of applying the magnetic write field to the medium. By heating the medium, the Kᵤ or the coercivity is reduced such that the magnetic write field is sufficient to write to the medium. Once the medium cools to ambient temperature, the medium has a sufficiently high value of coercivity to assure thermal stability of the recorded information.

### BRIEF SUMMARY OF THE INVENTION

The present invention relates an apparatus including a write element for writing to a medium. The apparatus is configured to effectuate an electrical potential difference between a portion of the apparatus and a portion of the medium such that a current flows between the apparatus and the medium to reduce a coercivity of the medium proximate to the write element.

### BRIEF DESCRIPTION OF THE DRAWINGS

FIG. 1 is a side view of a magnetic writer and a current assist electrode disposed relative to a magnetic medium.

FIG. 2 is a side view of a portion of a write pole proximate to the current assist electrode.

FIG. 3 is a medium confronting surface view of a write pole separated from the current assist electrode by an insulating material.

FIG. 4 is a side of a magnetic writer and a magnetic medium including a voltage source connected to a write pole.

### DETAILED DESCRIPTION

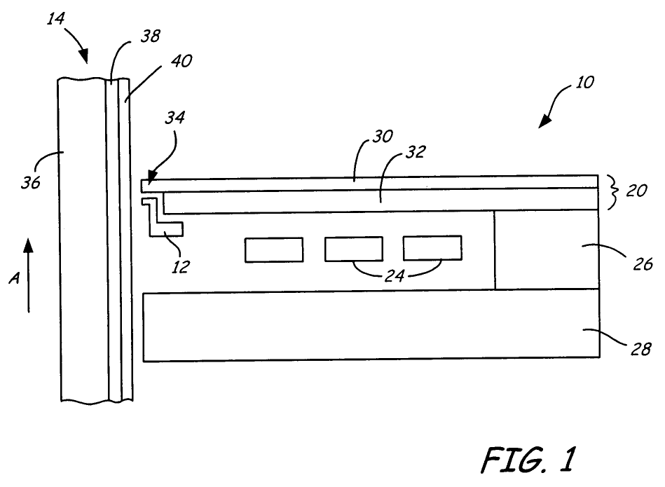

FIG. 1 is a side view of magnetic writer 10 and current assist electrode 12 disposed proximate to magnetic medium 14. Magnetic writer 10 includes write pole 20, conductive coils 24, back via 26, and return pole 28. Write pole 20, which includes main portion 30 and yoke portion 32, is connected to return pole 28 by back via 26 distal from the surface of magnetic writer 10 that confronts magnetic medium 14. Conductive coils 24 surround back via 26 such that turns of conductive coils 24 are disposed in the gap between write pole 20 and return pole 28.

Magnetic writer 10 is carried over the surface of magnetic medium 14, which is moved relative to magnetic writer 10 as indicated by arrow A such that write pole 20 is the trailing pole and is used to physically write data to magnetic medium 14. Conductive coils 24 surround back via 26 such that, when a write current is caused to flow through conductive coils 24, the magnetomotive force in the coils magnetizes write pole 20 and return pole 28. This causes a write field to be generated at pole tip 34 of main portion 30, which is used to write data to magnetic medium 14. The direction of the write field at pole tip 34, which is related to the state of the data written to magnetic medium 14 is related, is controllable based on the direction that the write current that flows through conductive coils 24.

Magnetic writer 10 is shown merely for purposes of illustrating a construction that may be used in conjunction with the current assisted recording of the present invention, and variations on the design may be made. For example, while write pole 20 includes main portion 30 and yoke portion 32, write pole 20 can also be comprised of a single layer of magnetic material. Also, magnetic writer 10 may include no return pole, or may include multiple return poles, such as a configuration including a leading return pole that is coupled to yoke portion 32 through a leading back gap closer and a trailing return pole that is coupled to main portion 30 through a trailing back gap closer. In addition, magnetic writer 10 is configured for writing data perpendicularly to magnetic medium 14, but magnetic writer 10 and magnetic medium 14 may also be configured to write data longitudinally. Furthermore, a magnetic reader may be provided adjacent to and carried over magnetic medium 14 on the same device as magnetic writer 10.

Magnetic medium 14 includes substrate 36, soft underlayer (SUL) 38, and medium layer 40. SUL 38 is disposed between substrate 36 and medium layer 40. Magnetic medium 14 is positioned proximate to magnetic writer 10 such that the surface of medium layer 40 opposite SUL 38 faces write pole 20. In some embodiments, substrate 36 is comprised of a non-magnetic material, such as aluminum and aluminum based alloys, SUL 38 is comprised of a magnetically soft (i.e., high permeability) material, and medium layer 40 is comprised of a granular material having a high perpendicular anisotropy and high coercivity.

SUL 38 is located below medium layer 40 of magnetic medium 14 and enhances the amplitude of the write field produced by the write pole 20. The image of the write field is produced in SUL 38 to enhance the field strength produced in magnetic medium 14. As the write field from write pole 20 (and in particular, pole tip 34) passes through medium layer 40, medium layer 40 is magnetized perpendicular to the medium plane to store data based on the write field direction. The flux density that diverges from pole tip 34 into SUL 38 returns through return pole 28. Return pole 28 is located a sufficient distance from write pole 20 such that the material of return pole 28 does not affect the magnetic flux of write pole 20.

In magnetic medium 14, medium layer 40 may be made of a material having a very high magnetic anisotropy at ambient temperatures to prevent magnetic instabilities caused by thermal energy at high areal densities. In order to facilitate writing to magnetic medium 14, medium layer 40 may be locally heated to reduce the coercivity of medium layer 40 so that the write field generated by write pole 20 can more easily direct the magnetization of the medium layer 40 during the temporary magnetic softening of the medium layer 40 caused by the heating. In order to accomplish this, current assist electrode 12 is provided proximate to write pole 20 and magnetic medium 14. As will be described in more detail herein, current assist electrode 12 is operable to provide a potential difference between current assist electrode 12 and magnetic medium 14. This potential difference results in localized Joule heating of the medium under current assist electrode 12 to temperatures that approach the Curie temperature of medium layer 40.

Magnetic medium 14 is shown merely for purposes of illustrations, and variations on the configuration of magnetic medium 14 can be made. For example, magnetic medium 14 may include a thermal barrier layer disposed between the SUL 38 and medium layer 40 and/or between substrate 36 and SUL 38 to provide a good thermal path for heat caused by the Joule heating to be distributed and dissipated. Also, while SUL 38 and medium layer 40 are shown as single layer structures, SUL 38 and medium layer 40 may also be formed as multilayer structures. In addition, magnetic medium 14 may be formed without SUL 38, or a thermal conductivity layer may be provided in place of SUL 38. Furthermore, magnetic medium 14 may be configured for use in conjunction with a longitudinal or oblique/tilted recording systems, and magnetic writer 10 may be configured for use with other types of media, including composite media, continuous/granular coupled (CGC) media, discrete track media, and bit-patterned media.

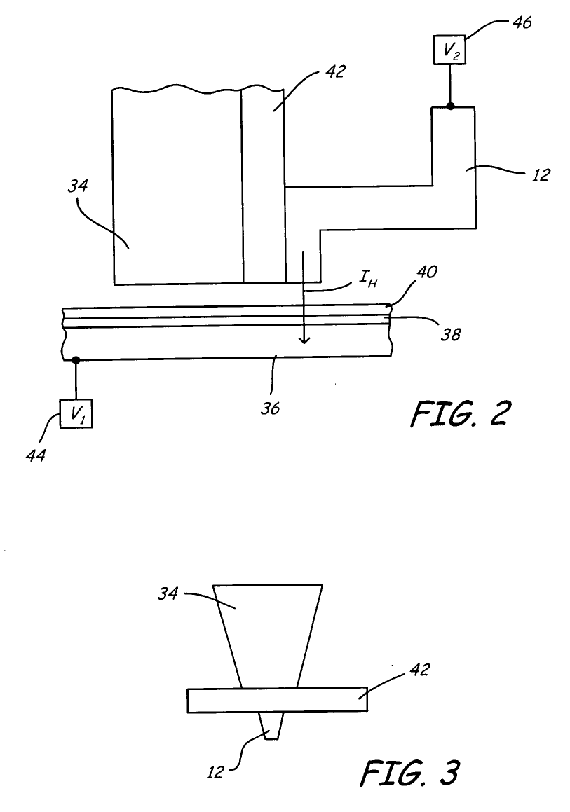

FIG. 2 is a side view of a portion of pole tip 34 and current assist electrode 12 proximate to magnetic medium 14. Current assist electrode 12 and magnetic medium 14 are comprised of conductive materials that may have conductivities from DC to AC frequencies in the microwave and millimeter range (e.g., up to 200 GHz). Current assist electrode 12 is separated from pole tip 34 by insulating material 42 to prevent conductance of current from current assist electrode 12 to write pole 20. In some embodiments, insulating material 42 separates pole tip 34 from current assist electrode 12 by a distance that is greater than the separation between pole tip 34 and magnetic medium 14. At the same time, the distance between current assist electrode 12 and pole tip 34 is small enough such that the heated portion of medium layer 40 has not cooled before the write field is provided to the heated portion by write pole 20. The thickness of insulating material 42 can be precisely controlled using known fabrication techniques, such as atomic layer deposition. In an alternative embodiment, insulating material 42 is removed such that current assist electrode 12 is adjacent to pole tip 34.

Magnetic medium 14 (and in particular substrate 36) is electrically coupled to a first voltage source 44 having a voltage V₁ and current assist electrode 12 is electrically coupled to a second voltage source 46 having a voltage V₂. During the recording process, voltage sources 44 and 46 are controlled such that voltage V₁ is different from voltage V₂. When voltages V₁ and V₂ are different, a current I_{H} is generated between current assist electrode 12 and magnetic medium 14. The separation between current assist electrode 12 and magnetic medium 14 is small enough such that current I_{H} is conducted across this separation by tunneling or field emission. In an alternative embodiment, current assist electrode 12 is disposed closer to magnetic medium 14 by, for example, forming current assist electrode 12 so as to protrude closer to magnetic medium 14 than pole tip 34. Current I_{H} causes localized heating in medium layer 40 under current assist electrode 12. In order to prevent current I_{H} from spreading in medium layer 40 beyond the profile of current assist electrode 12, additional layers that may be included on top of medium layer 40 (e.g., a lubrication layer and an overcoat layer) may be selected to have good conductive and thermal properties. The voltage difference between current assist electrode 12 and magnetic medium 14 may also cause eddy currents to develop in current assist electrode 12. These eddy currents are imaged in magnetic medium 14, which cause medium layer 40 to heat in the region of the imaged eddy currents.

Voltage source 44 may be maintained at a constant or reference voltage (e.g., ground) while voltage source 46 is controlled to provide a voltage difference between current assist electrode 12 and magnetic medium 14. Voltage source 46 may be an alternating current (AC) voltage source that provides a high frequency AC voltage V₂ (e.g., up to 200 GHz) to current assist electrode 12. The degree of heating in medium layer 40 below current assist electrode 12 is controllable by adjusting the amplitude and frequency of voltage V₂ supplied by voltage source 46. In some embodiments, the AC voltage source has a frequency about equal to a recording frequency of the magnetic writer 10 to about ten times the recording frequency of magnetic writer 10.

FIG. 3 is a medium confronting surface view of pole tip 34 separated from the current assist electrode 12 by insulating material 42. Pole tip 34 has a trapezoidal shape at magnetic medium 14 to decrease the dependence of the track width recorded by write pole 20 on the skew angle of magnetic writer 10 as it is carried over magnetic medium 14. This improves the recording density of magnetic writer 10 and reduces the bit error rate and side writing and erasure on adjacent tracks of magnetic medium 14. It should be noted that while pole tip 34 is shown having a trapezoidal shape, pole tip 34 may have any shape at magnetic medium 14 that is capable of generating a write field at magnetic medium 14 during the write process.

The portion of medium layer 40 that is heated due to the potential difference between current assist electrode 12 and magnetic medium 14 is related to the area and shape of current assist electrode 12 at medium layer 40. In order to increase the density of data that is recorded to magnetic medium 14, the surface of current assist electrode 12 that confronts magnetic medium 14 may have an area that is less than the area of pole tip 34 at magnetic medium 14, as is shown in FIG. 3. That is, the area of medium layer 40 that is heated is substantially confined to the portion of medium layer 40 that is below current assist electrode 12. Consequently, the coercivity of medium layer 40 is reduced in a region that has a size substantially similar to the medium confronting surface of current assist electrode 12. The strength of write field from pole tip 34 is such that data is only written to the heated region of medium layer 40, while the rest of medium layer 40 is not affected by the write field due to its high coercivity at ambient temperatures. While current assist electrode 12 is shown having a trapezoidal shape at magnetic medium 14, current assist electrode 12 may have any shape capable of providing control of the portion of magnetic medium 14 that is heated during the write process, including square, rectangular, elliptical, and rounded shapes.

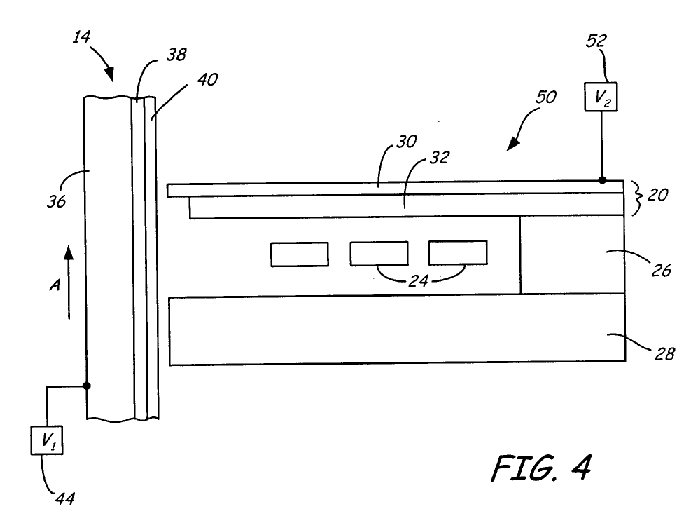

FIG. 4 is a side of a magnetic writer 50 for current assisted magnetic recording disposed proximate to magnetic medium 14. Magnetic medium 14 includes substrate 36, SUL 38, and medium 40 as described above. Magnetic writer 50 includes elements similar to magnetic writer 10 as described above, including write pole 20 (including main portion 30 and yoke portion 32), conductive coils 24 that surround back via 26, and return pole 28. Magnetic writer 50 is shown merely for purposes of illustrating a construction that may be used in conjunction with the current assisted recording of the present invention, and variations on this design may be made.

Magnetic medium 14 (and in particular substrate 36) is electrically coupled to a first voltage source 44 having a voltage V₁, similar to the embodiment shown in FIG. 1. However, in this embodiment write pole 20 is electrically coupled to a second voltage source 52 having a voltage V₂. During the recording process, voltage sources 44 and 52 are controlled such that voltage V₁ is different from voltage V₂. When voltages V₁ and V₂ are different, a current is generated between write pole 20 and magnetic medium 14. The separation between write pole 20 and magnetic medium 14 is small enough such that a current is conducted across this separation by tunneling or field emission. This current causes localized heating in medium layer 40 under write pole 20. In order to prevent current I_{H} from spreading in medium layer 40 beyond the profile of current assist electrode 12, additional layers that may be included on top of medium layer 40 (such as a lubrication layer and an overcoat layer) may be selected to have good conductive and thermal properties. The voltage difference between write pole 20 and magnetic medium 14 may also cause eddy currents to develop in write pole 20. These eddy currents are imaged in magnetic medium 14, which cause medium layer 40 to heat in the region of the imaged eddy currents.

Voltage source 44 may be maintained at a constant or reference voltage (e.g., ground) while voltage source 52 is controlled to provide a voltage difference between write pole 20 and magnetic medium 14. Voltage source 52 may be an alternating current (AC) voltage source that provides a high frequency AC voltage V₂ to write pole 20. The degree of heating in medium layer 40 below write pole 20 is controllable by adjusting the amplitude and frequency of voltage V₂ supplied by voltage source 52.

In summary, the present invention relates an apparatus including a write element for writing to a medium. The apparatus is configured to effectuate an electrical potential difference between a portion of the apparatus and a portion of the medium such that a current flows between the apparatus and the medium to reduce a coercivity of the medium proximate to the write element. The electrical potential difference causes a current to flow between the apparatus and the medium to reduce a coercivity of the medium proximate to the write element. This portion of the medium is heated to close to its Curie temperature, which reduces the write field needed to write to the medium. In one embodiment, the apparatus includes an electrode coupled to a voltage source to effectuate an electrical potential difference between a portion of the apparatus and a portion of the medium. The dimensions of the heated portion of the medium are controllable by adjusting the dimensions of the electrode at the medium confronting surface. Consequently, the portion of the medium that is heated can be made smaller than the write element at the medium confronting surface, which allows for denser recording on the medium. In another embodiment, a voltage source is coupled to the write element, which allows the current to flow from the write element to heat a portion of the medium.

Although the present invention has been described with reference to preferred embodiments, workers skilled in the art will recognize that changes may be made in form and detail without departing from the spirit and scope of the invention. For example, while the present invention has been described with regard to perpendicular recording applications, the principles of the present invention are also applicable to longitudinal and oblique/tilted recording applications.

1. An apparatus including a write element for writing to a medium, wherein the apparatus is configured to effectuate an electrical potential difference between a portion of the apparatus and a portion of the medium such that a current flows between the apparatus and the medium to reduce a coercivity of the medium proximate to the write element.

2. The apparatus of claim 1, wherein the apparatus comprises an electrode coupled to a voltage source to effectuate an electrical potential difference between a portion of the apparatus and a portion of the medium.

3. The apparatus of claim 2, wherein an area of the electrode less than an area of the write element at the medium.

4. The apparatus of claim 2, wherein the electrode is disposed proximate to a leading edge of the write element.

5. The apparatus of claim 2, wherein the electrode is separated from the write element by an insulating material.

6. The apparatus of claim 2, wherein the electrode has a shape at the medium selected from the group consisting of square, rectangular, elliptical, and rounded.

7. The apparatus of claim 2, wherein the voltage source is an AC voltage source.

8. The apparatus of claim 1, wherein a voltage source is coupled to the write element to effectuate an electrical potential difference between a portion of the apparatus and a portion of the medium.

9. The apparatus of claim 8, wherein the voltage source is an AC voltage source.

10. A system comprising:
a magnetic medium having a reference voltage;
a write element for writing to the magnetic medium; and
an electrode proximate to the write element having an applied voltage such that a difference between the applied voltage and the reference voltage induces a current between the electrode and the medium that causes heating in the medium proximate to the write element.

11. The system of claim 10, wherein an area of the electrode less than an area of the write element at the medium.

12. The system of claim 10, wherein the electrode is disposed proximate to a leading edge of the write element.

13. The system of claim 10, wherein the electrode is separated from the write element by an insulating material.

14. The system of claim 10, wherein the electrode has a shape at the medium selected from the group consisting of square, rectangular, elliptical, and rounded.

15. The system of claim 10, wherein the applied voltage is an AC voltage.

16. The system of claim 10, wherein the difference between the applied voltage and the reference voltage induces eddy currents in the medium that cause heating in the medium proximate to the write element.

17. A method for writing to a magnetic medium, the method comprising:
heating a region of the magnetic medium with an electrical current; and
generating a write field with the magnetic recording head at the heated region.

18. The method of claim 17, wherein heating a region of the magnetic medium with an electrical current comprises:
applying a first voltage to the magnetic medium; and
applying a second voltage to a portion of a magnetic recording head such that a difference between first voltage and the second voltage induces a current between the magnetic recording head and the magnetic medium that causes heating in a region of the magnetic medium.

19. The method of claim 18, wherein applying a first voltage to the magnetic medium comprises electrically grounding the magnetic medium.

20. The method of claim 18, wherein applying a second voltage to a portion of a magnetic recording head comprises applying an AC voltage to a portion of the magnetic recording head.

21. The method of claim 20, wherein the AC voltage has a frequency of at least about a recording frequency of the magnetic recording head.

22. The method of claim 18, wherein the portion of the magnetic recording head comprises a write pole.

23. The method of claim 22, wherein the portion of the magnetic recording head comprises an electrode disposed with respect to the write pole.

24. The method of claim 23, wherein an area of the electrode less than an area of the write element at the medium.

25. The method of claim 23, wherein the electrode is disposed proximate to a leading edge of the write element.
